(19) United States
(12) Patent Application Publication
(10) Pub. No.: US 2009/0259768 A1
(43) Pub. Date: Oct. 15, 2009

(54) Application load distribution system in packet data networks

(76) Inventors: Gilbert J. McGrath, Middletown, NJ (US); Reuben Klein, East Brunswick, NJ (US); Chaoxin Qiu, Austin, TX (US); Steven A. Siegel, Mendham, NJ (US); Kermit Hal Purdy, Bernardsville, NJ (US)

Correspondence Address: AT & T Legal Department - WS;Attn: Patent Docketing, Room 2A-207, One AT & T Way, Bedminster, NJ, 07921, US

(21) Appl. No.: 12/082,791

(22) Filed: Apr. 14, 2008

(51) Int. Cl. G06F 15/173

(52) U.S. Cl. 709/241

(57) ABSTRACT

The present invention routes an application request to at least one of a plurality of sites in a packet data network. Session Initiation Protocol (SIP) messages that establish initial dialogs and SIP messages that are stand-alone requests are sent from a call session control function system to a SIP application load distribution system. The SIP application load distribution system routes a SIP message to at least one destination site, based at least in part on user-defined local state data and a user-defined application load distribution policy. Local state data is sent from a plurality of sites to an application management and health checking system. Local state data may be sent autonomously from the plurality of sites. Local state data may also be sent from the plurality of sites in response to a request issued by the application management and health checking system.

### BACKGROUND OF THE INVENTION

The present invention relates generally to load distribution in packet data networks, and more particularly to application load distribution in packet data networks using the Session Initiation Protocol.

Packet data networks, such as Internet Protocol (IP) networks, were originally developed to transport data. Packet data networks, however, are increasingly being deployed to provide a wide range of multimedia services, including data, voice, and video. For increased reliability and performance of a transport network, network equipment, such as routers and switches, are often deployed in a redundant architecture. For example, if one router fails, traffic may be redirected to another router. Redundancy may be deployed in several modes, such as hot spares, cold spares, and load sharing.

In addition to redundant network transport equipment, increased reliability and performance of overall services may be provided by redundant applications. That is, multiple instances of an application, for example, may be loaded onto multiple, geographically dispersed, servers. Redundant applications provide a number of advantages. One example is disaster recovery. If a disaster destroys a server in California, for example, redundancy may allow customers to access the same application in Massachusetts. Another example is faster response time. A customer in California, for example, could download videos from a video server in California, and a customer in Massachusetts could download videos from a video server in Massachusetts. The traffic load on any one server may be reduced, and the network path between a customer's home video unit and a video server may be shortened. A third example is flexibility in scheduling customer assistance services. A customer's request placed at 9 am EST, for example, could be routed to a call center in Massachusetts, while a customer's request at 9 pm EST could be routed to a call center in California.

If there are multiple locations providing multiple instances of an application, an application load distribution system may be used to specify at least one destination location. Various criteria may be used to specify a destination location. For example, time of day, load on a server, and network administration policies may all be factors. Application load distribution may be implemented by various processes. One process, for example, is domain name mapping. For example, when a customer requests access to a website, he may open an Internet browser and enter the domain name of the website. A Domain Name Server (DNS) then translates the domain name to the IP address of a destination server. One method for application load distribution is to return different IP addresses, corresponding to different destination servers, in response to different access requests. Another process, for example, is network traffic load balancing, in which the network traffic to available destination servers is distributed equally.

Although existing processes for application load distribution may be effective in some instances, each has various shortcomings for general network installations. DNS mapping, for example, may be effective for long-term averaging of a large number of service requests. Under many circumstances, however, it may not be effective over shorter time periods for a smaller number of service requests. As another example, network traffic load balancing may not be viable for many networks. Servicing application requests across multiple instances of applications across multiple locations via multiple network paths may present complex, dynamic traffic flows which are difficult to control.

To date, packet data networks have primarily utilized a fixed-line, packet-switched infrastructure. Increasingly, however, packet data networks interfacing with mobile networks are being deployed to provide services to a wider range of customers. One architecture being deployed to provide multimedia services to fixed-line and mobile users incorporates an Internet Protocol Multimedia Subsystem (IMS), which uses signalling messages specified by the Session Initiation Protocol (SIP). What is needed is an application load distribution system that operates effectively with an IMS and similar network architectures, that flexibly adapts to a wide range of network configurations, and that flexibly adapts to a wide range of services. An application load distribution system with small overhead (utilization of server and network resources) is advantageous. An application load distribution system which accommodates, and does not interfere with, other concurrently deployed load distribution systems (such as DNS mapping or network traffic load balancing) is further advantageous.

### BRIEF SUMMARY OF THE INVENTION

The present invention routes an application request to at least one of a plurality of sites in a packet data network. Session Initiation Protocol (SIP) messages that establish initial dialogs and SIP messages that are stand-alone requests are sent from a call session control function system to a SIP application load distribution system. The SIP application load distribution system routes a SIP message to at least one destination site, based at least in part on user-defined local state data and a user-defined application load distribution policy. Local state data is sent from a plurality of sites to an application management and health checking system. Local state data may be sent autonomously from the plurality of sites. Local state data may also be sent from the plurality of sites in response to a request issued by the application management and health checking system.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a packet data network with redundant applications available from multiple sites;

FIG. 2 shows a high-level schematic of a packet data network including an Internet Protocol Multimedia Subsystem;

FIG. 3 shows a high-level schematic of a system for application load distribution;

FIG. 4 shows a detailed schematic of a SIP application load distribution system;

FIG. 5A shows a standard SIP message exchange sequence;

FIG. 5B shows a SIP message exchange sequence in which messages are routed through a SIP application load distribution system;

FIG. 6A shows examples of INVITE message structures;

FIG. 6B shows examples of TRYING message structures;

FIG. 6C shows examples of RINGING message structures;

FIG. 6D shows examples of OK message structures; and

FIG. 7 shows a high-level schematic of a computer which may be used to implement a SIP application load distribution system.

### DETAILED DESCRIPTION

From a functional perspective, a customer may request access to an application across a packet data network, such as an Internet Protocol (IP) network. Herein, an application refers to a function or service. An application may, for example, be provided by software, either directly or indirectly. Examples of applications include consumer applications, such as information searches, file downloads, phone calls, and streaming video. Another example of a consumer application is technical assistance provided by a customer representative at a call center. Applications, for example, may also refer to network applications, such as operations, administration, maintenance, and provisioning (OAM&P). Herein, the term “server equipment” refers to a hardware element or hardware system, and its associated operating software. Examples of server equipment include network servers and workstations. Other examples of server equipment include consumer equipment such as laptop computers, desktop computers, personal digital assistants, and mobile phones. Server equipment may further include network equipment such as routers, switches, and traffic monitors (for example, if the application is network traffic analysis).

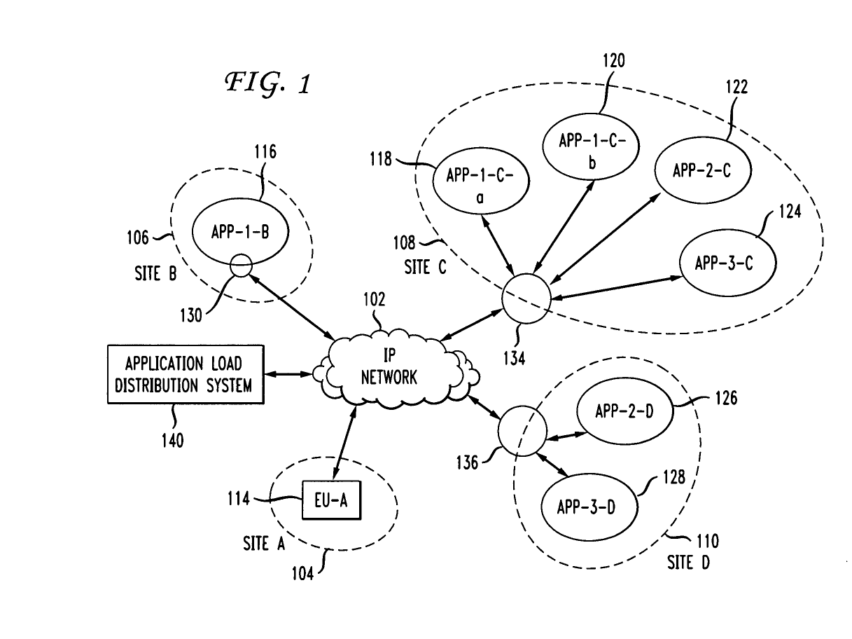

FIG. 1 shows a high-level schematic of an example of a communications network. Customer EU-A 114, located at Site A 104, accesses applications via IP network 102. In the example shown, EU-A 114 may access three different applications, App-1, App-2, and App-3. Herein, multiple instances of the same application refer to the same service or function provided by different sources. The sources, for example, may refer to different sites, different server equipment, or different software running on the same server equipment. As discussed above, multiple sources of an application, for example, may be configured in hot spare, cold spare, or load share modes. Multiple sources of an application may be present within a single site. For example, there may be redundant server equipment within a single site. To simplify the terminology, an application “site” refers herein to a set of application sources which are logically linked. The logical link is user-defined. For example, a site may refer to a specific server equipment or a set of sources within a specific geographical location. As a further example, a site may refer to a set of sources within a specific administrative domain, which may be geographically dispersed. For example, if an application is provided by multiple service providers, a site may refer to a specific service provider. A site, for example, may be identified by a user-defined identifier, which, herein, is referred to as a uniform resource identifier (URI). Examples of URIs include IP addresses and domain names. Herein, routing an application request to a site identified by a URI is also referred to as routing an application request to a URI.

In the example shown in FIG. 1, application App-1 may be accessed via App-1-B 116 in Site B 106, App-1-C-a 118 in Site C 108, and App-1-C-b 120, also in Site C 108. App-2 may be accessed via App-2-C 122 in Site C 108 and App-2-D 126 in Site D 110. App-3 may be accessed via App-3-C 124 in Site C 108 and App-3-D 128 at Site D 110.

In general, EU-A 114 is unaware of the destination site to which its application request is routed by IP network 102. Herein, an application load distribution system (ALDS) is a system which routes an application request to at least one destination site. In general, an application request may be concurrently routed to more than one destination site; for example, if high reliability is desired. In the example shown in FIG. 1, ALDS 140 routes application requests transported across IP network 102. In general, ALDS 140 may be implemented on various hardware and software. In general, an IP network may have multiple application load distribution systems, which may, for example, be configured in hot spare, cold spare, or load share modes.

In FIG. 1, App-1-B 116 resides in server equipment 130. Application load distribution system ALDS 140, for example, may then route an application request to the IP address of server equipment 130. In general, an ALDS may route an application request to a site controller, which may, for example, be identified by a URI. A site controller is a system or element which controls communication of messages to one or more application sources. The set of application sources controlled by a site controller is referred to herein as the domain of the site controller. A site controller receives an application request and then routes the application request to at least one application source within its domain. In some instances, the sender of the request may communicate with the site controller only and may not be aware of the application sources to which the site controller routes the request. In other instances, the sender of the request may communicate with both the site controller and at least one application source within the domain of the site controller.

In FIG. 1, site controller 134 is the site controller for Site C 108. The domain of site controller 134 is App-1-C-a 118, App-1-C-b 120, App-2-C 122 and App-3-C 124. Site controller 136 is the site controller for Site D 110. The domain of site controller 136 is App-2-D 126 and App-3-D 128. For example, a site controller may be a network load balancer. As a further example, a site controller may be a proxy server.

According to an embodiment of the invention, ALDS 140 may specify at least one destination site based on multiple criteria, including high-level business rules, network engineering rules, and the number of concurrent customers. As an example of application load distribution based on network traffic parameters, assume, in FIG. 1, that there is heavy network traffic between Site A 104 and Site B 106 and that there is light network traffic between Site A 104 and Site C 108. If customer EU-A 114 requests access to App-1, then ALDS 140 may direct the request to Site C 108. As an example of application load distribution based on the number of concurrent customers, assume that App-2 provides downloads of songs. If 12,000 customers are accessing App-2 from Site C 108 and 6,000 customers are accessing App-2 from Site D 110, for example, ALDS 140 may direct new requests to Site D 110.

As an example of application load distribution based on business rules, assume that Site C 108 is a call center in California and Site D 110 is a call center in Massachusetts. A business rule may specify that a request from a customer at 9 am EST be directed to Site D 110, and that a request from a customer at 9 pm EST be directed to Site C 108. Another example of a business rule, for example, is a contractual agreement between a service provider and a service consumer. Herein, a business rule refers to any user-defined rule.

In an advantageous embodiment, multiple application load distribution criteria may be used in combination and may vary dynamically. Herein, the overall process by which an application request is routed to at least one destination site is referred to as an application load distribution policy. An application load distribution policy may be based at least in part on high-level business rules, network engineering rules, and the number of concurrent customers. An application load distribution policy, for example, may be represented by an algorithm and input parameters to the algorithm. Input parameters may, for example, be network traffic along a route, number of concurrent users accessing server equipment, and local state data (discussed below). In an embodiment, an application load distribution policy and input parameters are provided as input to ALDS 140. An application request is routed by ALDS 140 to at least one destination site based at least in part on the application load distribution policy and input parameters.

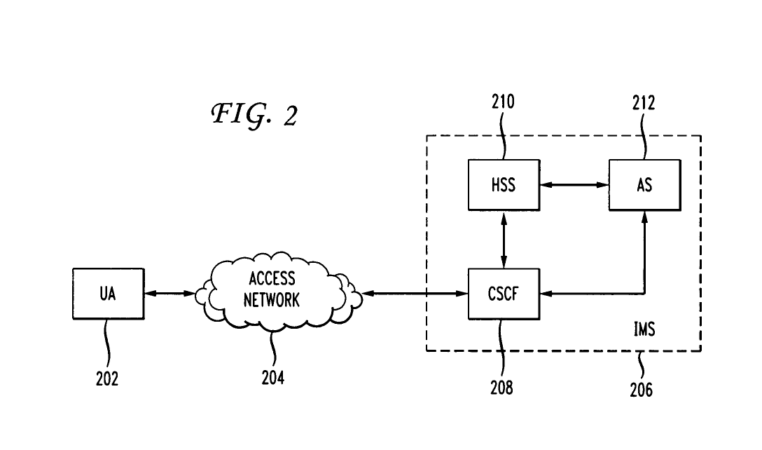

FIG. 2 shows a high-level schematic of the functional architecture of an example of a packet data network which provides multimedia services via an Internet Protocol Multimedia Subsystem (IMS). In general, packet data networks and IMSs are complex systems with multiple architectures, multiple functional elements, multiple hardware implementations, and multiple software implementations. FIG. 2 shows an example of a simplified network to illustrate embodiments of the invention. One skilled in the art, however, may develop embodiments applicable to other configurations of an IMS.

In the example shown in FIG. 2, a customer accesses multimedia services via consumer equipment, such as a computer or cell phone. The access function residing in the consumer equipment is-a terminating user agent UA 202. User agent UA 202 accesses IMS 206 via access network 204. Examples of access network 204 include a fixed-line IP network, a public switched telephone network, and a cellular network. IMS 206 includes call session control function CSCF 208, home subscriber server HSS 210, and application server AS 212.

Communications in an IMS network are separated into a signalling plane, which initiates and controls sessions, and a media plane, which transports the media content (such as voice, video, and data). The signalling plane uses the Session Initialization Protocol (SIP). Examples of SIP messages are discussed below. Home subscriber server HSS 210 is the central repository for customer-related subscription data required to handle multimedia sessions. Examples of customer-related subscription data include location information, security information, and services to which the customer has subscribed. Call session control function CSCF 208 is the central node of the signalling plane. It is essentially a SIP server, but it performs session control as well. All the SIP signalling that UA 202 sends, and all the SIP signalling that UA 202 receives, traverses CSCF 208, which inspects every SIP message and determines whether the SIP signalling should visit one or more application servers en route toward the final destination. One of the main functions of CSCF 208 is to provide SIP routing services. Application server AS 212 is a SIP entity that hosts and executes services. To avoid confusion with other uses of the term “application” and “application server”, herein, an IMS application server is referred to as an application, wherein, as discussed above, an application refers to a function or service.

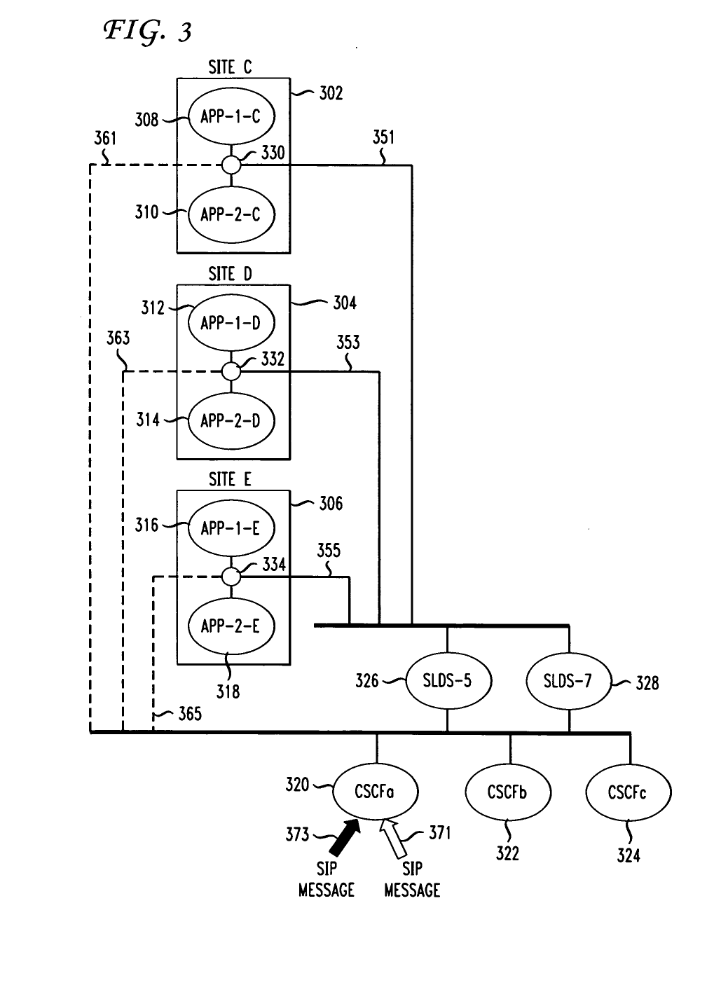

Embodiments of the invention perform application load distribution in an IMS-based network. FIG. 3 shows a high-level schematic of an example of an application load distribution system according to an embodiment of the invention. Shown are three sites, Site C 302-Site E 306. There are two applications, App-1 and App-2, which reside in all three sites: App-1-C 308 and App-2-C 310 reside in Site C 302; App-1-D 312 and App-2-D 314 reside in Site D 304; and App-1-E 316 and App-2-E 318 reside in Site E 306. At each site, messages are routed to and from an application via a site controller. Site controller 330-site controller 334 control Site C 302-Site E 306, respectively.

In the example shown in FIG. 3, there are three call session control functions, CSCFa 320, CSCFb 322, and CSCFc 324. Each call session control function may, for example, correspond to a different customer. In general, CSCFa 320, CSCFb 322, and CSCFc 324, may be distributed across multiple server equipment in multiple locations (not shown in FIG. 3). Also shown are two new functional elements, referred to herein as SIP load distribution systems (SLDSs): SLDS-5 326 and SLDS-7 328, details of which are discussed below. In general, a SIP load distribution system may be implemented on various hardware elements and hardware systems, and their associated software elements and software systems.

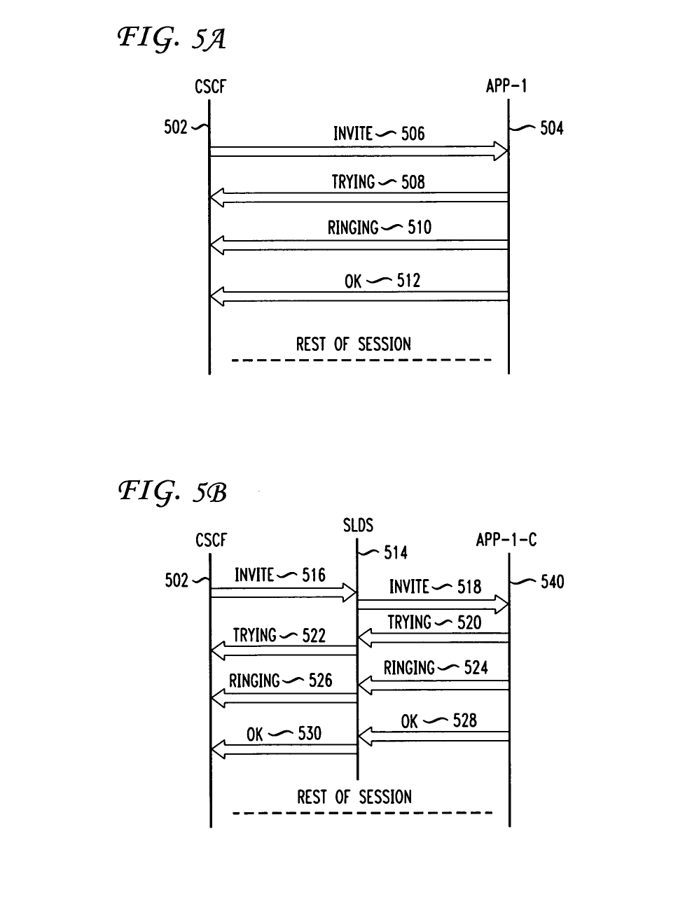

Two user agents exchange a number of SIP messages in order to establish and terminate a session. The exchange of a set of SIP messages between two user agents is referred to as a SIP dialog. An example of a SIP dialog is given below in FIG. 5A. In an embodiment of the invention, a SIP message is first routed to an SLDS if it is a request that establishes initial dialogs or if it is a stand-alone request. A SIP stand-alone request is an isolated transaction requiring a single final response. To simplify the terminology, a SIP message is referred to as a distributable SIP message if it is either a SIP message that establishes initial dialogs or a SIP message that is a stand-alone request. The CSCF routes distributable SIP messages to applications in a sequence based on the initial filter criteria downloaded from the customer profile stored in the HSS. Examples of distributable SIP messages include INVITE, OPTIONS, REGISTER, SUBSCRIBE, MESSAGE, and PUBLISH. Examples of messages which are not routed to a SLDS include ACK, BYE, CANCEL, UPDATE, NOTIFY, PRACK, REFER, and INFO.

When a subscriber (customer) sends a request to access an application, the CSCF refers to the service profile stored in the subscriber's HSS. In an embodiment, the URI associated with the application may be the URI of a SLDS instead of the URI of a destination site for the application. In FIG. 3, lines 351-365 represent virtual paths connecting various functional elements. In general, a specific CSCF may access more than one SLDS. In general, more than one CSCF may access a specific SLDS. In general, a specific SLDS may process more than one application. Virtual paths 361-365 (represented by dashed lines) connect CSCFa 320-CSCFc 324 to Site C 302-Site E 306, respectively. Virtual paths 351-355 (represented by solid lines) connect SLDS-5 326 and SLDS-7 328 to Site C 302-Site E 306, respectively. At Site C 302-Site E 306, virtual paths 351-365 terminate at site controller 330-site controller 334, respectively. One skilled in the art may develop embodiments with other network architectures.

As an example of a message flow, consider a subscriber, associated with CSCFa 320, that requests access to App-1. SIP Message 371 is a distributable SIP message (for example, an INVITE) and is first routed from CSCFa 320 to SLDS-5 326 (based on the service profile and initial filter criteria). The SIP message is then routed via virtual path 355 from SLDS-5 326 to Site E 306, for example, based on the application policy in effect in SLDS-5 326. SIP Message 373 is not a distributable SIP message (for example, a CANCEL), as determined by the initial filter criteria, and is routed via virtual path 365 from CSCFa 320 to Site E 306.

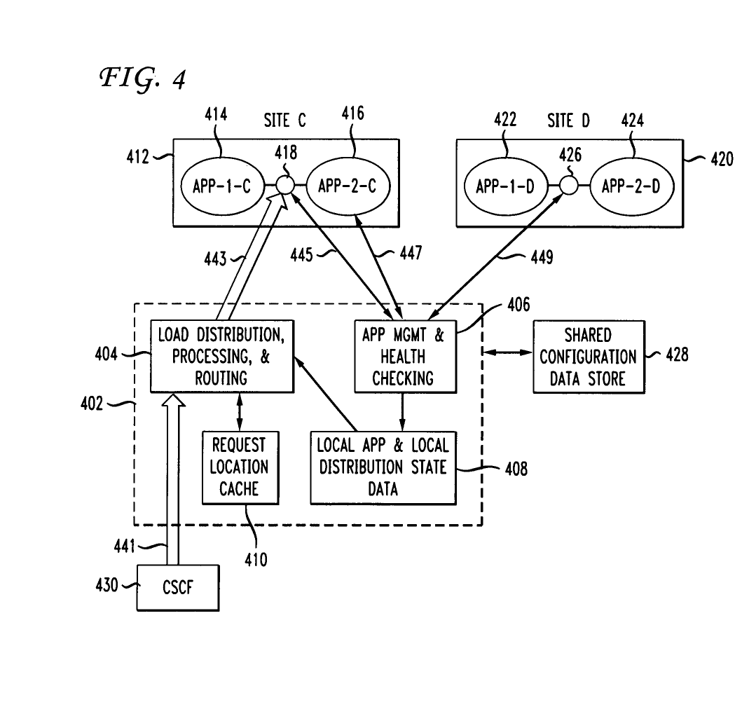

FIG. 4 shows a more detailed view of an application load distribution system, according to an embodiment of the invention. A subscriber sends a request to access an application. The request is processed by CSCF system 430. CSCF system 430 then sends a SIP request message 441 to SLD system 402. SLD system 402 comprises four major subsystems: load distribution, processing, and routing (LDPR) system 404, application management and health checking (AMHC) system 406, request location cache system 410, and local state data storage system 408.

In this example, SLD system 402 communicates with site controller 418 located in Site C 412 and site controller 426 located in Site D 420. Application App-1-C 414 and application App-2-C 416 reside in Site C 412. Redundant applications, App-1-D 422 and App-2-D 424, respectively, reside in Site D 420. SLD system 402 further communicates with shared configuration data storage system 428, which may be shared across multiple SLD systems distributed across multiple sites. Shared configuration data storage system 428, for example, may contain information on applications configuration, load distribution rules, load distribution configurations, and application load distribution policies.

AMHC system 406 exchanges diagnostic messages with Site C 412 and Site D 420. Herein, a diagnostic message is a message which reports any user-defined information. For example, diagnostic messages may report the state of server equipment and applications. Diagnostic messages may be autonomously sent by a site; for example, by server equipment and applications. Diagnostic messages autonomously sent by server equipment and applications may be sent periodically (for example, every hour), at user-specified times (for example, at 6 am and 11 pm), and when user-defined conditions are met (for example, when a fault occurs). In general, diagnostic messages autonomously sent by a site may be sent according to user-defined criteria.

Diagnostic messages may also be sent by a site in response to a request for information issued by AMHC system 406. A request for information, for example, may be issued periodically, at user-specified times, when user-defined conditions are met, and on demand (for example, by a manual command issued by a network administrator). In general, a request for information may be issued according to user-defined criteria.

In the example shown in FIG. 4, AMHC system 406 exchanges diagnostic messages with Site C 412 via communication path 445 to site controller 418 and diagnostic messages with Site D 420 via communication path 449 to site controller 426. AMHC system 406 further exchanges diagnostic messages directly with App-2-C 416 via communication path 447, bypassing site controller 418. As discussed above, a diagnostic message may be initiated from a site. For example, if Site C 412 develops a fault condition, Site C 412 may send an alarm via communication path 445 to AMHC system 406. As another example, if the central processing unit (CPU) utilization of server equipment residing in Site C 412 exceeds a user-defined threshold, Site C 412 may send an alert via communication path 445 to AMHC system 406. Similarly, if the execution time exceeds a user-defined threshold, App-1-D 422 may send an alert via site controller 426 and communication path 449 to AMHC system 406. As another example, App-1-D 422 may periodically report the number of simultaneous users.

As discussed above, a site may also send diagnostic messages to AMHC system 406 in response to requests from AMHC system 406. For example, via communication path 449, AMHC system 406 may poll Site D 420 for information such as CPU utilization, memory usage, input/output utilization, and chassis temperature of server equipment residing in Site D 420. In response, Site D 420 may return the requested information. As another example, via communication path 447, AMHC system 406 may request App-2-C 416 to report the number of simultaneous users and the average execution time. In response, App-2-C 416 may return the requested information.

The information in the diagnostic messages sent to AMHC system 406 is stored in local state data storage system 408. Local state data includes, for example, the state of specific sites, specific server equipment, and specific applications. In addition to the examples discussed above, local state data may include other information, such as whether a server equipment is online or not, and whether an application is active or suspended. Local state data may further include information on the transport network; for example, traffic on network paths. Herein, local state data refers to user-defined data affecting execution of an application request. Local state data may comprise user-defined information received from diagnostic messages. This information may be accessed by load distribution, processing, and routing (LDPR) system 404, which is a stateless proxy. Based on the information in local state data storage system 408 and the information, including application load distribution policies, in shared configuration data storage system 428, LDPR system 404 specifies at least one destination site for a new request. In the example shown in FIG. 4, LDPR system 404 receives SIP request 441 and routes it as SIP request 443 to Site C 412. LDPR system 404 also communicates with request location cache system 410, which tracks the previous destination site. If a message needs to be retransmitted, LDPR system 404 queries the information in request location cache system 410 to route the retransmitted message to the previous destination site. For example, if SIP request 441 is not successfully received by App-1-C 414, no response will be sent. SIP message 441 may then be retransmitted by CSCF 430, and LDPR system 404 will query request location cache system 410 and retransmit SIP message 443 to Site C 412.

FIG. 5A shows an example of a SIP dialog, according to the prior art. Note that the numbers in square brackets [. . . ] are figure reference numbers; they are not SIP message codes. CSCF [502] sends INVITE [506] to App-1 [504], which then returns TRYING [508] to CSCF [502]. App-1 [504] then sends RINGING [510] to CSCF [502]. In this example, App-1 [504] is able to establish a dialog and sends OK [512] to CSCF [502].

FIG. 5B shows the same dialog, except the messages pass through SLDS [514], according to an embodiment of the invention. CSCF [502] sends INVITE [516] to SLDS [514], which then forwards INVITE [516] as INVITE [518] to App-1-C [540], which then returns TRYING [520] to SLDS [514]. SLDS [514] then forwards TRYING [520] as TRYING [522] to CSCF [502]. App-1-C [540] then sends RINGING [524] to SLDS [514], which then forwards RINGING [524] as RINGING [526] to CSCF [502]. In this example, App-1-C [540] is able to establish a dialog and sends OK [528] to SLDS [514], which then forwards OK [528] as OK [530] to CSCF [502].

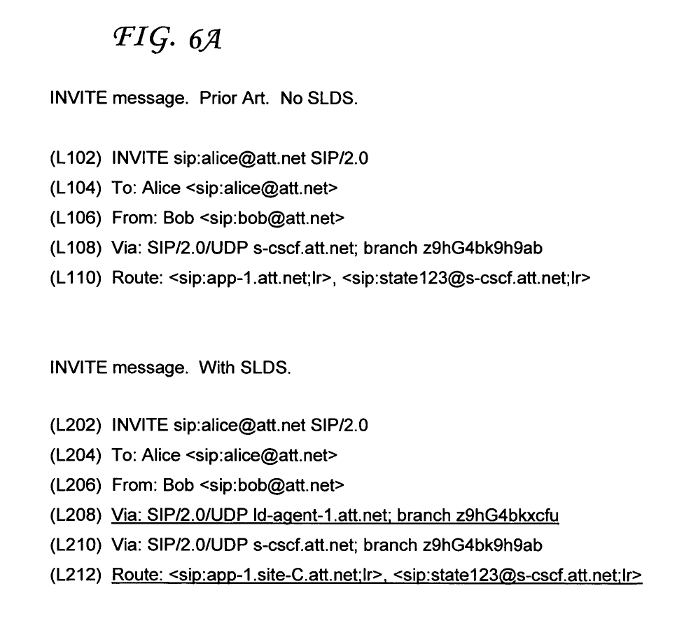

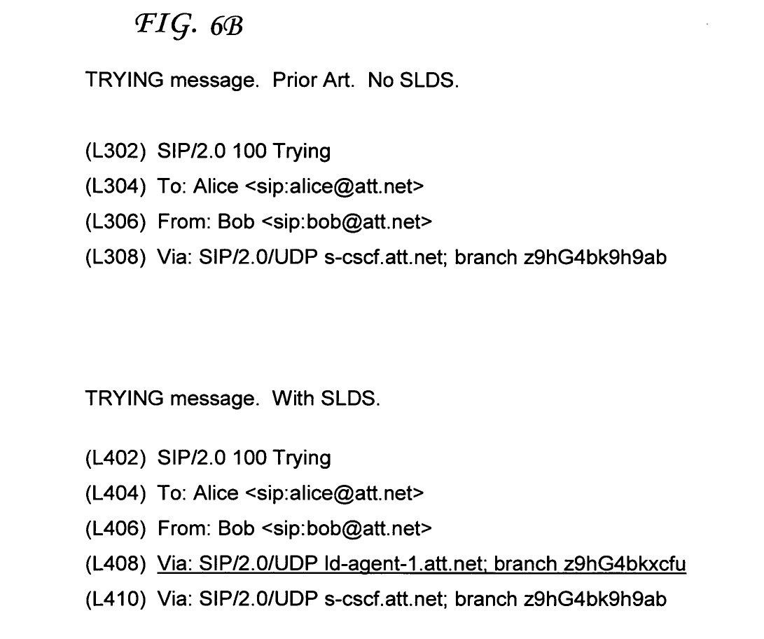

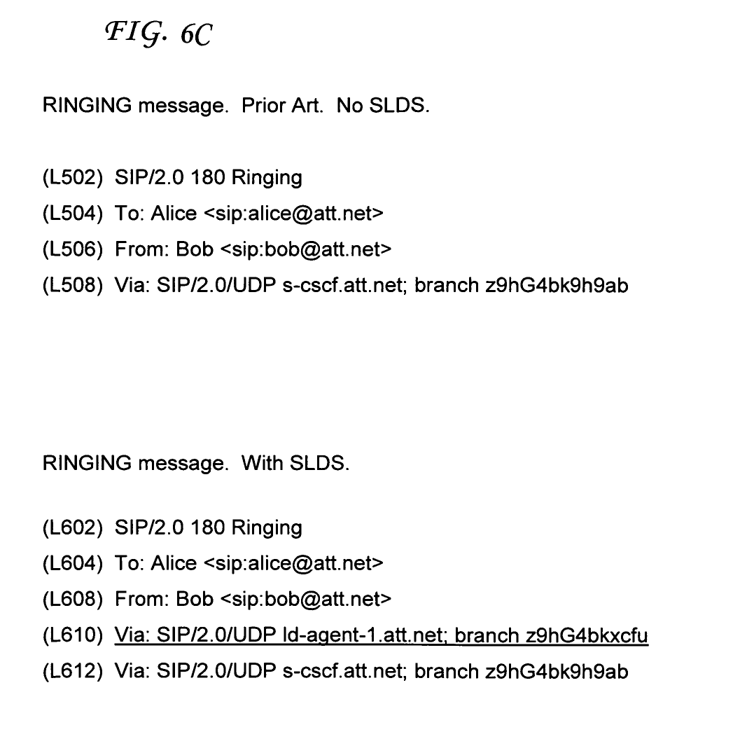

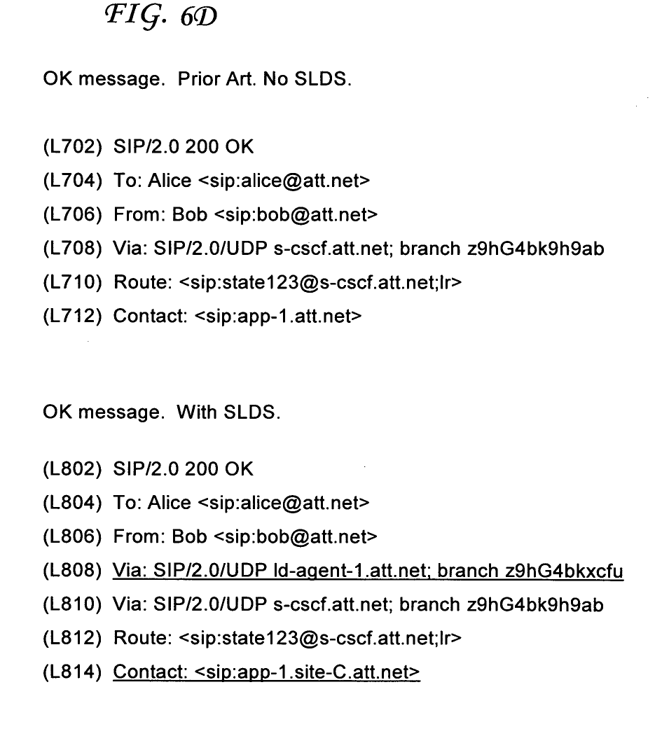

FIG. 6A-FIG. 6D show examples of SIP messages for INVITE, TRYING, RINGING, and OK, respectively. In the message fields, CSCF [502] is referenced as s-cscf.att.net; App-1 [504] is referenced as app-1.att.net; App-1-C [540] is referenced as app-1.site-C.att.net; and SLDS [514] is referenced as Id-agent-1.att.net. Line numbers are preceded by ‘L’ and enclosed in parentheses. For example, (L102) refers to line 102.

FIG. 6A shows the message structure of an INVITE message. Lines (L102)-(L110) show the fields for a prior-art INVITE message (no SLDS), such as INVITE [506]. In (L108), the Via field tracks all the proxies that a message has traversed. In this instance, the proxy is s-cscf.att.net. In (L110), the Route field indicates that the message is routed to the endpoint identified by app-1.att.net. When used in INVITE [506], app-1.att.net in (L110) resolves to the endpoint App-1 [504]. When used in INVITE [516], app-1.att.net resolves to the endpoint SLDS [514]. Lines (L202)-(L212) show the fields for an INVITE [518] sent to App-1-C after the message has been processed by SLDS [514], according to an embodiment of the invention. In (L208) and (L210), the Via fields indicate that the message was first proxied by CSCF [502], referenced as s-cscf.att.net, and then proxied by SLDS [514], referenced as Id-agent-1.att.net. In (L212), notice that SLDS [514] modified the Route field, indicating that the message is now being routed to App-1-C [540], referenced as app-1.site-C.att.net.

FIG. 6B shows the message structure of a TRYING message. Lines (L302)-(L308) show the fields for a prior-art TRYING message (no SLDS), such as TRYING [508] in FIG. 5A. In (L308), the Via field indicates that the message traversed the proxy s-cscf.att.net. Lines (L402)-(L410) show the fields for a TRYING message processed with an SLDS, for example TRYING [520] in FIG. 5. In (L408), the Via field indicates that the message is first routed to SLDS [514] referenced as Id-agent-1.att.net. The SLDS [514] then removes (L408) and then forwards the message to the CSCF [502], referenced as s-cscf.att.net in the Via field in (L410). This corresponds to TRYING [522].

FIG. 6C shows the message structure of a RINGING message. Lines (L502)-(L508) show the fields for a prior-art RINGING message (no SLDS), such as RINGING [510] in FIG. 5A. In (L508), the Via field indicates that the message traversed the proxy s-cscf.att.net. Lines (L602)-(L612) show the fields for a RINGING message processed with an SLDS, for example RINGING [524] in FIG. 5. In (L610), the Via field indicates that the message is first routed to SLDS [514], referenced as Id-agent-1.att.net. SLDS [514] removes (L 610) and then forwards the message to CSCF [502], referenced as s-cscf.att.net in the Via field in (L612). This corresponds to RINGING [526].

FIG. 6D shows the message structure of an OK message. Lines (L702)-(L712) show the fields for a prior-art OK message (no SLDS), such as OK [512] in FIG. 5A. In (L708), the Via field indicates that the message traversed the proxy s-cscf.att.net. In (L712), the Contact field indicates that the application is accessed at app-1.att.net. Lines (L802)-(L814) show the fields for an OK message processed with an SLDS, for example OK [528] in FIG. 5B. In (L808), the Via field indicates that the message is first routed to SLDS [514], referenced as Id-agent-1.att.net. SLDS [514] removes (L 808) and then forwards the message to CSCF [502], referenced as s-cscf.att.net in the Via field in (L810). This corresponds to OK [530]. In (L814), the Contact field indicates that the application is accessed at app-1.site-C.att.net.

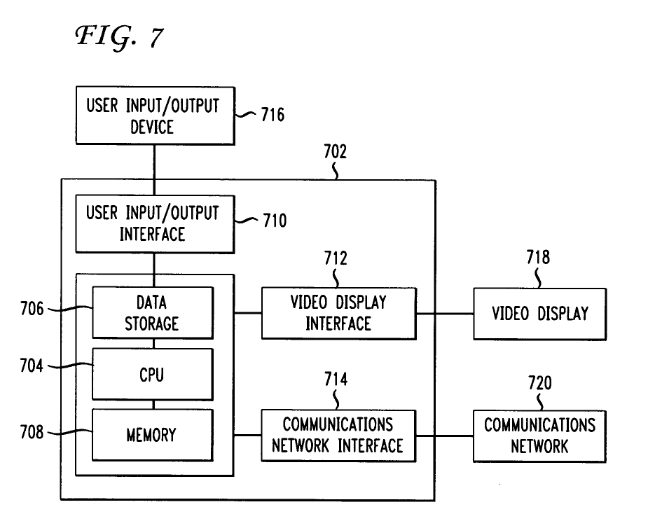

One embodiment of a SIP load distribution system may be implemented using a computer. As shown in FIG. 7, computer 702 may be any type of well-known computer comprising a central processing unit (CPU) 704, memory 708, data storage 706, and user input/output interface 710. Data storage 706 may comprise a hard drive or non-volatile memory. User input/output interface 710 may comprise a connection to a user input device 716, such as a keyboard or mouse. As is well known, a computer operates under control of computer software which defines the overall operation of the computer and applications. CPU 704 controls the overall operation of the computer and applications by executing computer program instructions which define the overall operation and applications. The computer program instructions may be stored in data storage 706 and loaded into memory 708 when execution of the program instructions is desired. Computer 702 may further comprise a video display interface 712, which may transform signals from CPU 704 to signals which may drive video display 718. Computer 702 may further comprise one or more network interfaces. For example, communications network interface 714 may comprise a connection to an Internet Protocol (IP) communications network 720. Computers are well known in the art and will not be described in detail herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for routing an application request to at least one of a plurality of sites in a packet data network, comprising the steps of:
receiving a distributable Session Initiation Protocol (SIP) message;
receiving an application load distribution policy;
receiving local state data; and
routing said distributable SIP message to at least one destination site, based at least in part on said application load distribution policy and said local state data.

2. The method of claim 1, further comprising the step of generating business rules.

3. The method of claim 1, further comprising the step of generating network engineering rules.

4. The method of claim 1, wherein said step of receiving local state data further comprises receiving local state data autonomously sent by at least one of said plurality of sites.

5. The method of claim 1, wherein said step of receiving local state data further comprises receiving said local state data in response to a message sent to at least one of said plurality of sites.

6. The method of claim 1, further comprising the step of sending a message to at least one of said plurality of sites requesting said local state data.

7. The method of claim 1, wherein said step of receiving a distributable SIP message further comprises receiving said distributable SIP message from a call session control function system (CSCF).

8. The method of claim 1, further comprising the step of storing the identity of said at least one destination site in a request location cache system.

9. An apparatus for routing an application request to at least one of a plurality of sites in a packet data network, comprising:
means for receiving a distributable Session Initiation Protocol (SIP) message;
means for receiving an application load distribution policy;
means for receiving local state data; and
means for routing said distributable SIP message to at least one destination site, based at least in part on said application load distribution policy and said local state data.

10. The apparatus of claim 9, further comprising means for generating business rules.

11. The apparatus of claim 9, further comprising means for generating network engineering rules.

12. The apparatus of claim 9, wherein said means for receiving local state data further comprises means for receiving local state data autonomously sent by at least one of said plurality of sites.

13. The apparatus of claim 9, wherein said means for receiving local state data further comprises means for receiving said local state data in response to a message sent to at least one of said plurality of sites.

14. The apparatus of claim 9, further comprising means for sending a message to at least one of said plurality of sites requesting said local state data.

15. The apparatus of claim 9, wherein said means for receiving a distributable SIP message further comprise means for receiving said distributable SIP message from a CSCF.

16. The apparatus of claim 9, further comprising means for storing the identity of said at least one destination site in a request location cache system.

17. A computer readable medium storing computer program instructions for routing an application request to at least one of a plurality of sites in a packet data network, the computer program instructions defining the steps of:
receiving a distributable Session Initiation Protocol (SIP) message;
receiving an application load distribution policy;
receiving local state data; and
routing said distributable SIP message to at least one destination site, based at least in part on said application load distribution policy and said local state data.

18. The computer readable medium of claim 17, wherein said computer program instructions defining the step of routing an application request to at least one of a plurality of sites in a packet data network further comprise computer program instructions defining the step of generating business rules.

19. The computer readable medium of claim 17, wherein said computer program instructions defining the step of routing an application request to at least one of a plurality of sites in a packet data network further comprise computer program instructions defining the step of generating network engineering rules.

20. The computer readable medium of claim 17, wherein said computer instructions defining the step of receiving local state data further comprise computer instructions defining the step of receiving local state data autonomously sent by at least one of said plurality of sites.

21. The computer readable medium of claim 17, wherein said computer program instructions defining the step of receiving local state data further comprise computer program instructions defining the step of receiving said local state data in response to a message sent to at least one of said plurality of sites.

22. The computer readable medium of claim 17, wherein said computer program instructions defining the step of routing an application request to at least one of a plurality of sites in a packet data network further comprise computer program instructions defining the step of sending a message to at least one of said plurality of sites requesting said local state data.

23. The computer readable medium of claim 17, wherein said computer instructions defining the step of receiving a distributable SIP message further comprise computer instructions defining the step of receiving said distributable SIP message from a CSCF.

24. The computer readable medium of claim 17, wherein said computer program instructions defining the step of routing an application request to at least one of said plurality of sites in a packet data network further comprise computer program instructions defining the step of storing the identity of said at least one destination site in a request location cache system.
